(19) United States
(12) Patent Application Publication
(10) Pub. No.: US 2007/0083485 A1
(43) Pub. Date: Apr. 12, 2007

(54) File server, file providing method and recording medium

(76) Inventor: Sunao Hashimoto, Kawasaki-shi (JP)

Correspondence Address: GAUTHIER & CONNORS, LLP, 225 FRANKLIN STREET, SUITE 2300, BOSTON, MA, 02110, US

(21) Appl. No.: 11/452,837

(22) Filed: Jun. 14, 2006

(30) Foreign Application Priority Data
Oct. 12, 2005 (JP) 2005-297278

(51) Int. Cl. G06F 17/30

(52) U.S. Cl. 707/1

(57) ABSTRACT

There is provided a computer readable medium storing a program causing a computer to execute a process for providing a file in response to a file request. The process includes acquiring, when a file request is received from a client, a file ID that uniquely identifies the requested file and a directory path from file location information that is indicated in the received file request; judging whether or not the file corresponding to the acquired file ID exists on the acquired directory path; and if, as a result of the judgment, the file corresponding to the acquired file ID exists, acquiring the file corresponding to the acquired file ID and providing the acquired file as the requested file to the client, wherein if, as a result of the judgment, a file corresponding to the acquired file ID does not exist, a current directory path corresponding to the acquired file ID is determined, file location information indicating the determined current directory path and the acquired file ID is generated, and the generated file location information is provided to the client in response to the file request.

### PRIORITY INFORMATION

This application claims priority to Japanese Patent Application No. 2005-297278, filed on Oct. 12, 2005, which is incorporated herein by reference in its entirety.

### BACKGROUND

1. Technical Field

The present invention relates to a file server for managing multiple files.

2. Related Art

A technique is known in which a file server manages files by appending a unique identifier called a handle to each file. Then, as a URL for a file, a virtual URL, in which are specified the server name of the relevant system and the handle of the file, is provided to the user, and not a URL that shows the conventional file location (combination of server name and a path to a directory indicating a storage location of the file within the server). When the user uses the virtual URL to access the system, the system identifies the location of the file from its handle and provides it to the user. This mechanism allows a file to be found in response to a user request regardless of the location (directory) where the file has moved to in the data management system.

On the other hand, when accessing a file using FTP (File Transfer Protocol), the URL includes a notation of the path of the directory indicating the storage location of the file. Thus, the user can determine the storage location of the file corresponding to the URL by referencing the URL. For example, when accessing a file using the URL of ftp://abc.co.jp/pub/incoming/readme.txt, the user can determine that the readme.txt file is stored in the directory path /pub/incoming/ of an FTP server having a host name of abc.co.jp.

### SUMMARY

According to one aspect of the present invention, there is provided a computer readable medium storing a program causing a computer to execute a process for providing a file in response to a file request. The process includes acquiring, when a file request is received from a client, a file ID that uniquely identifies the requested file and a directory path from file location information that is indicated in the received file request; judging whether or not the file corresponding to the acquired file ID exists on the acquired directory path; and if, as a result of the judgment, the file corresponding to the acquired file ID exists, acquiring the file corresponding to the acquired file ID and providing the acquired file as the requested file to the client, wherein if, as a result of the judgment, a file corresponding to the acquired file ID does not exist, a current directory path corresponding to the acquired file ID is determined, file location information indicating the determined current directory path and the acquired file ID is generated, and the generated file location information is provided to the client in response to the file request.

### BRIEF DESCRIPTION OF THE DRAWINGS

Embodiments of the present invention will be described in detail based on the following figures, wherein:

FIG. 1 shows a configuration of the file management system in the embodiment and the first through third and fifth modified examples;

FIG. 2 shows one example of file location information;

FIG. 3 is a functional block diagram of a file server in the embodiment and the first through fourth modified examples;

FIG. 4 shows one example of a hierarchical structure of the virtual directory;

FIG. 5 shows one example of virtual directory information;

FIG. 6 shows one example of file information;

FIG. 7 is a flowchart showing the procedure when the file request processor in the embodiment receives a file request;

FIG. 8 is a flowchart showing the procedure when the file request processor in the first modified example receives a file request;

FIG. 9 shows one example of file location information;

FIG. 10 shows one example of a hierarchical structure of a virtual directory;

FIG. 11 shows one example of virtual directory information;

FIG. 12 shows one example of file information;

FIG. 13 shows one example of a hierarchical structure of the virtual directory;

FIG. 14 shows one example of file information;

FIG. 15 is a flowchart showing the procedure when the file request processor in the second modified example receives a file request;

FIG. 16 is a flowchart showing the procedure when the file request processor in the third modified example receives a file request;

FIG. 17 shows a configuration of the file management system in the fourth modified example;

FIG. 18 is a flowchart showing the procedure when the file request processor in the fourth modified example inquires at another file server as to whether or not the requested file exists;

FIG. 19 is a flowchart showing the procedure when the file request processor in the fourth modified example receives an inquiry from another file server as to whether or not the requested file exists;

FIG. 20 shows a functional block diagram of the file server in the fifth modified example;

FIG. 21 shows one example of movement history; and

FIG. 22 shows one example of file location information.

### DETAILED DESCRIPTION OF THE PREFERRED EMBODIMENTS

Embodiments of the present invention will be described with reference to the attached drawings.

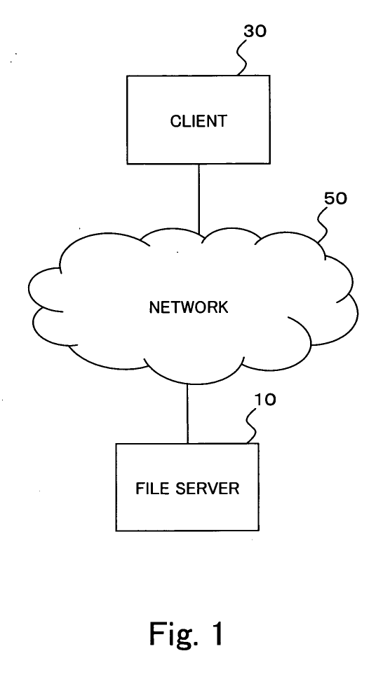

FIG. 1 is a diagram showing the system organization of a file management system in the embodiment. This system includes a file server 10 and a client 30, both of which are connected to a network 50, such as a LAN (Local Area Network) or the Internet.

The file server 10 manages an actual directory indicating an actual storage location of a file and a virtual directory indicating a virtual storage location of the file. The file generally refers to a collection of data, such as text data, image data, video data, and so forth, that can be interchanged with the file server 10 and the client 30 via the network 50.

The client 30 transmits a file request including file location information on the requested file to the file server 10. On the basis of the file location information received from the client 30, the file server 10 searches for the requested file and provides the obtained file to the client 30.

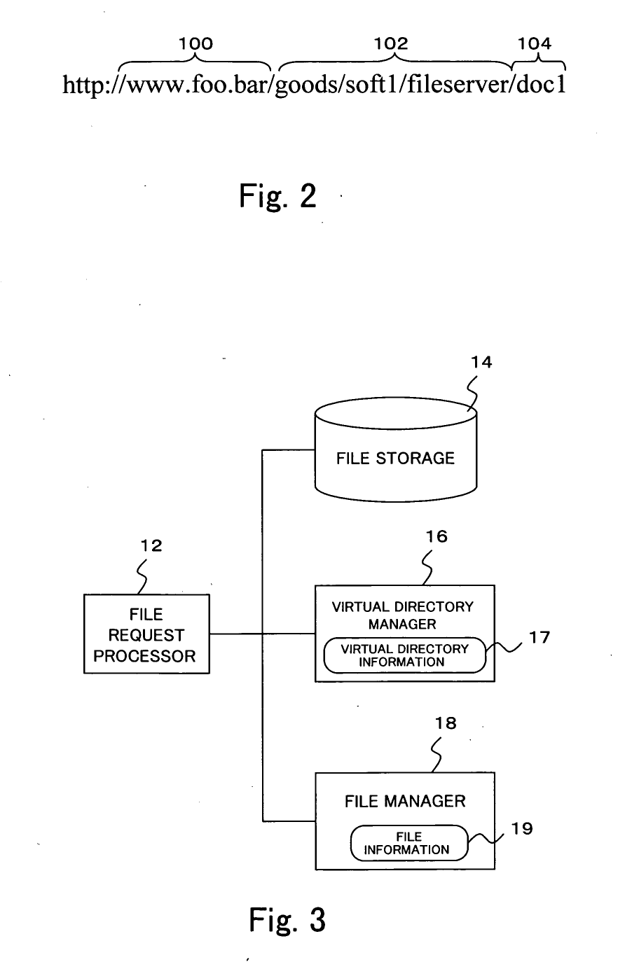

The file location information has a globally unique file ID for uniquely identifying at least the requested file and a virtual directory path indicating a virtual storage location of the requested file. The file location information is described, for example, by using a URL (Uniform Resource Locator) notation. FIG. 2 shows a host name 100 of the file request destination, a virtual directory path 102 of the requested file, and a file ID 104 of the requested file.

As a globally unique file ID, 128-bit identification information called a UUID (Universally Unique IDentifier) or a GUID (Globally Unique IDentifier) can be used. Incidentally, to ensure global uniqueness, the UUID includes, for example, the time the UUID was created or a MAC (Media Access Control) address of a network card that is installed in the machine used to create the UUID.

FIG. 3 is a functional block diagram of the file server 10 in the embodiment. In FIG. 3, a file request processor 12 receives the file request that is transmitted from the client 30, searches for the requested file on the basis of the file location information indicated in the file request, and transmits the obtained file as the requested file to the client 30. A file storage 14 stores files under respectively specified actual directories.

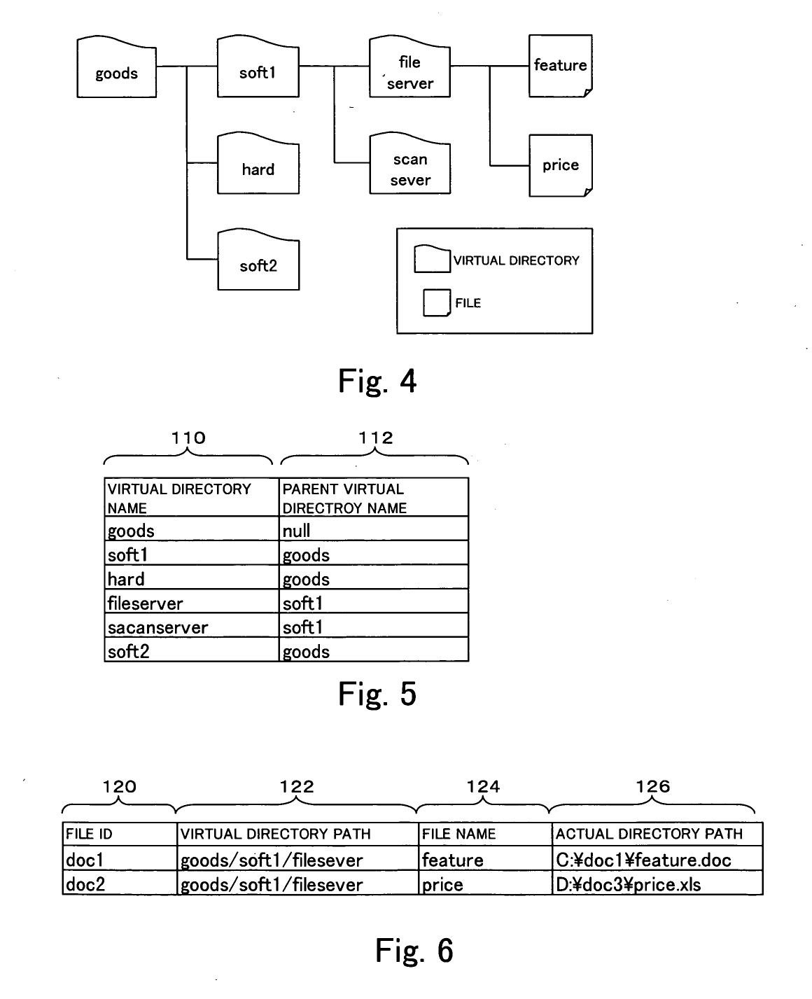

A virtual directory manager 16 retains virtual directory information 17. When the virtual directory has a hierarchical structure shown in FIG. 4, the virtual directory information 17 has the information shown in FIG. 5. As shown in FIG. 5, in the virtual directory information 17 indicates an association between a virtual directory name 110 of the virtual directory and a virtual directory name 112 of a parent virtual directory one level above. In FIG. 5, a virtual directory having a parent virtual directory name of “null” is a root directory. The file request processor 12 can confirm the structure of the current virtual directory by referencing the virtual directory information 17.

A file manager 18 retains file information 19. FIG. 6 shows one example of the file information 19. As shown in FIG. 6, the file information 19 indicates an association of a file ID 120, a virtual directory path 122 showing the virtual storage location of a file, a file name 124, and an actual directory path 126 showing the actual storage location of a file. The file request processor 12 can confirm the virtual directory showing the virtual storage location of a file and the actual directory showing the actual storage location of a file by referencing the file information 19.

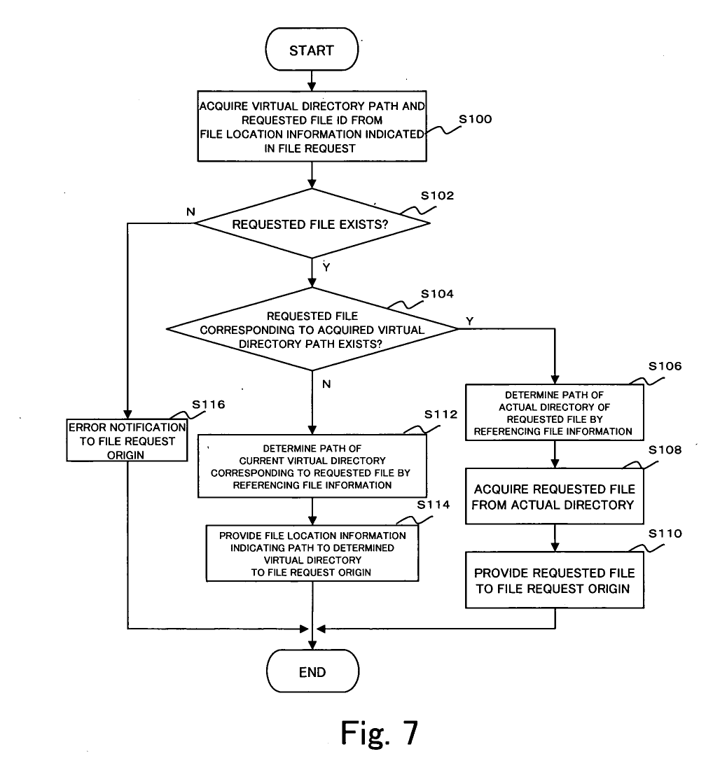

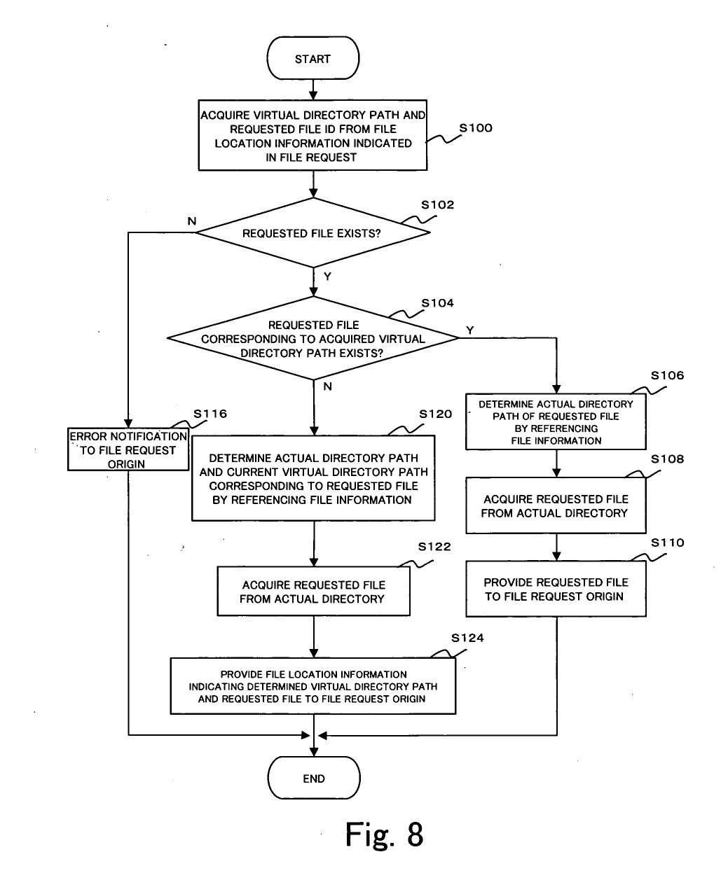

Next, a procedure of the file request processor 12 is described with reference to the flowchart shown in FIG. 7 for a case where a file request is received from the client 30.

When the file request processor 12 receives a file request from the client 30, a virtual directory path and a file ID of the requested file are acquired (S100) from the file storage location that is indicated in the file request. The file request processor 12 judges whether or not (S102) the requested file exists by referencing the file information 19. Namely, the file request processor 12 searches the file IDs that are registered in the file 19 for the file ID of the requested file. As a result of the judgment, if the requested file does not exist (judgment result of S102 is a negative “N”), the file request processor 12 issues an error notification (S116) to the client 30 originating the file request indicating that the requested file does not exist.

On the other hand, as a result of the judgment at S102, if the requested file exists (judgment result of S102 is an affirmative “Y”), the file request processor 12 judges whether the requested file exists (S104) on the acquired virtual directory path by referencing the file information 19. Namely, it is judged whether or not the information having a combination of the acquired virtual directory path and the acquired file ID has been registered in the file information 19. As a result of the judgment, if the requested file exists on the acquired virtual directory path (judgment result at S104 is “Y”), the file request processor 12 determines (S106) the actual directory path corresponding to the acquired file ID by referencing the file information 19. Next, the file request processor 12 acquires the requested file (S108) from the actual directory shown at the lowest level of the determined actual directory path and provides the requested file (S110) to the client 30 originating the file request.

On the other hand, as a result of the judgment at S104, if the requested file does not exist on the acquired virtual directory path (judgment result at S104 is “N”), the file request processor 12 judges that the requested file has moved from the virtual directory path that was indicated in the file location information. The file request processor 12 then determines the current virtual directory path (S112) corresponding to the file ID of the requested file by referencing the file information 19. Next, the file request processor 12 generates new file location information indicating the determined virtual directory path and the file ID of the requested file, and provides (S114) the generated file location information to the client 30 originating the file request. If the client 30 is provided with file location information in response to the file request from the file server 10, the requested file is judged to have moved so a new file request that indicates the provided file location information is transmitted to the file server 10.

According to this embodiment as described above, the client 30 is provided with new file location information even if the requested file has moved and the file request is made to the file server 10 using previous file location information. Thus, the client 30 can ultimately acquire the requested file if the file is again requested using the new file location information. Furthermore, since the new file location information is provided to the client 30 in response to the file request, the user can determine that the requested file has moved to another virtual directory. Moreover, the file location information that is used when the client 30 requests a file includes a virtual directory path indicating the virtual storage location of the file. Thus, by referencing the file location information, the user can determine under what directory the file exists.

Next, a first modified example of the embodiment will be described. In the first modified example where the requested file has already moved to another virtual directory, the difference with the above-mentioned embodiment is the file request processor 12 provides the file location information together with the requested file to the client 30 originating the request in response to the file request.

The procedure of the file request processor 12 in the first modified example where a file request is received from the client 30 will be described with reference to the flowchart shown in FIG. 8. Processes herein that are identical to those in FIG. 7 are assigned identical reference characters and their descriptions will be omitted. The processes from S104 will be described.

In FIG. 8, when the requested file has already moved to another virtual directory, namely, when the judgment result at S104 is “N”, the file request processor 12 determines (S120) the actual directory path and the current virtual directory path corresponding to the requested file by referencing the file information 19. Next, the file request processor 12 acquires (S122) the requested file from the actual directory located at the lowest level of the actual directory path that was determined. Furthermore, the file request processor 12 generates new file location information indicating the current virtual directory path that was determined and provides (S124) the file location information and the acquired requested file to the client 30 originating the file request.

According to the first modified example as described above, if the client 30 makes a file request to the file server 10 using the previous file location information, the requested file and new file location information can be acquired in response to the file request even in the case where the requested file has moved. The user then can determine which virtual directory the file was moved to.

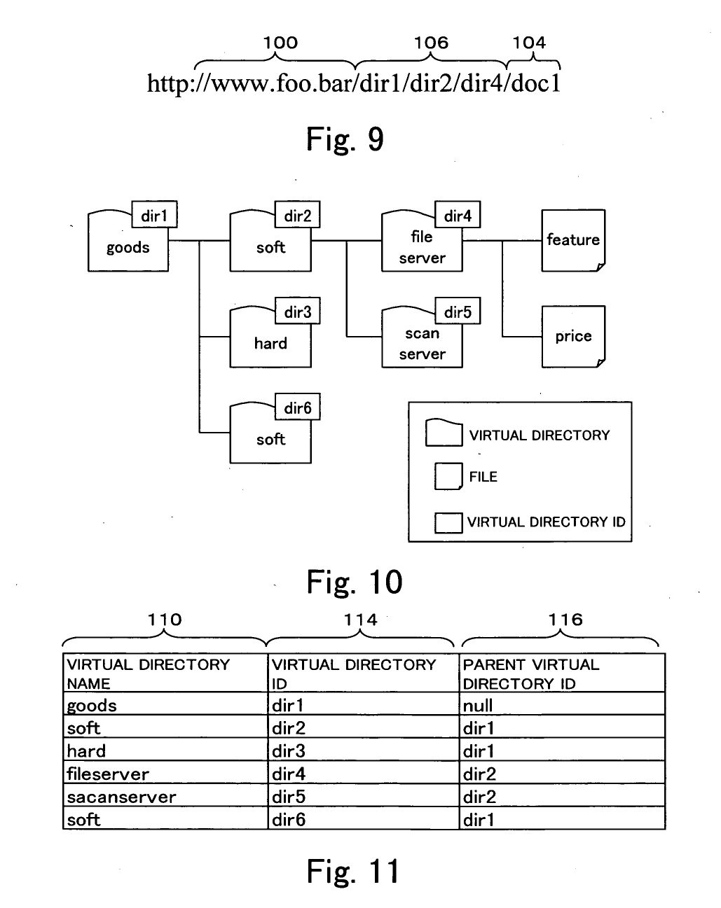

Next, a second modified example of the embodiment will be described. The second modified example differs from the above-mentioned embodiment and the first modified example in that the virtual directory path indicated in the file location information is configured from a virtual directory ID that globally and uniquely identifies the virtual directory. Like the file ID, the virtual directory ID can adopt UUID or GUID. FIG. 9 shows one example of file location information in the second modified example when a URL is used. As shown in FIG. 9, the file location information includes the host name 100 of the file request destination, a virtual directory path 106 formed from the virtual directory ID, and the file ID 104 of the requested file.

FIG. 10 shows one example of a hierarchical structure of the virtual directory in the second modified example. As shown in FIG. 10, a globally unique virtual directory ID is assigned to each virtual directory in the second modified example. By assigning a globally unique virtual directory ID to the virtual directory in this manner, virtual directories having the same name can exist in the same level, such as the directories “soft” shown in FIG. 10.

FIG. 11 shows one example of the virtual directory information 17 that is retained in the virtual directory manager 16 in the second modified example. As shown in FIG. 10, the virtual directory information 17 in the second modified example indicates an association among the virtual directory name 110, a virtual directory ID 114 for the virtual directory, and positioned one level above this virtual directory a parent virtual directory ID 116.

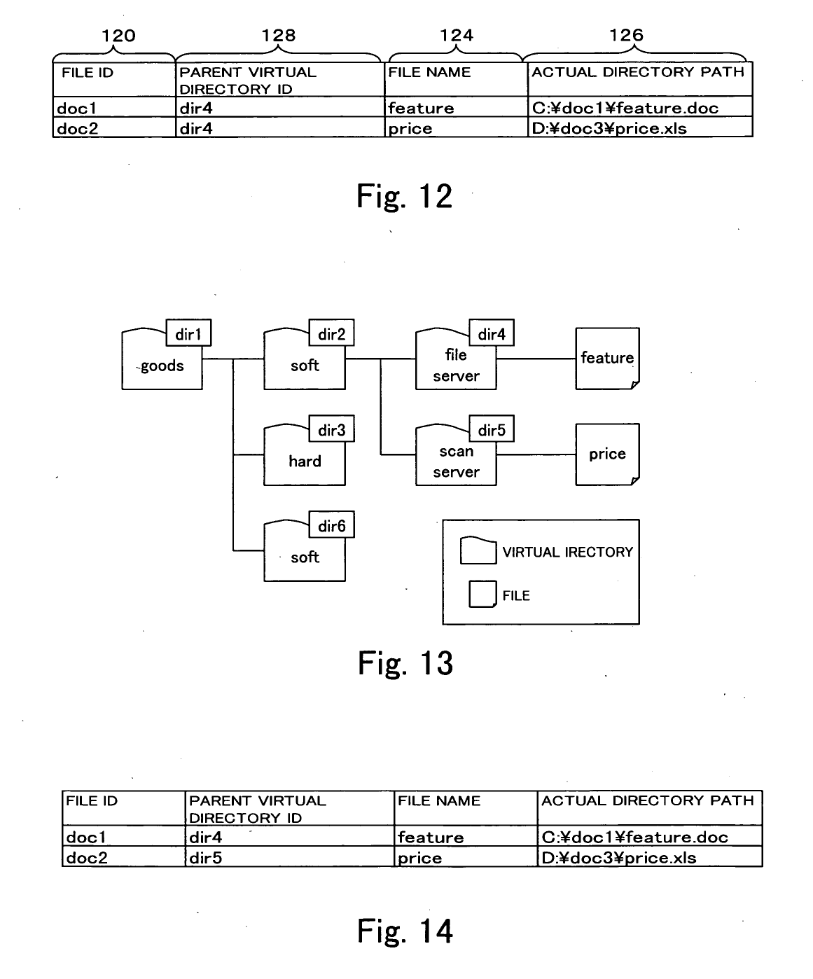

FIG. 12 shows one example of the file information 19 that is retained in the file manager 18 in the second modified example. As shown in FIG. 12, the file information 19 in the second modified example indicates an association among the file ID 120, a parent virtual directory ID 128 (which is the virtual storage location of the file), the file name 124, and the actual directory path 126 (which is the actual storage location of the file).

In the second modified example, a globally unique virtual directory ID is assigned to each virtual directory as described above. Thus, if the virtual directory ID of the parent virtual directory for the virtual storage location of the file can be determined, the file request processor 12 can determine the virtual directory path for the virtual storage location of the file by collating the virtual directory ID and the virtual directory information 17. Thus, in the second modified example, instead of the virtual directory path 122 for the virtual storage location of the file, the parent virtual directory ID 128 for the virtual storage location of the file is indicated in the file information 19.

When the file moves in the embodiment or the first modified example, it is necessary for the file manager 18 to determine all the virtual directories from the destination virtual directory to the root directory located higher than the virtual directory and to reregister into the file information 19 the virtual directory path that is formed from the determined virtual directories. On the other hand, in the second modified example, even if the file moves, the file manager 18 need only determine the destination virtual directory and reregister into the file information 19 the virtual directory ID of the determined virtual directory. For example, as shown in FIG. 13, if the file “price” has moved from virtual directory “fileserver” to virtual directory “scanserver”, the file manager 18 need only change the parent virtual directory ID for file “price” from “dir4” to “dir5” the in the file information 19.

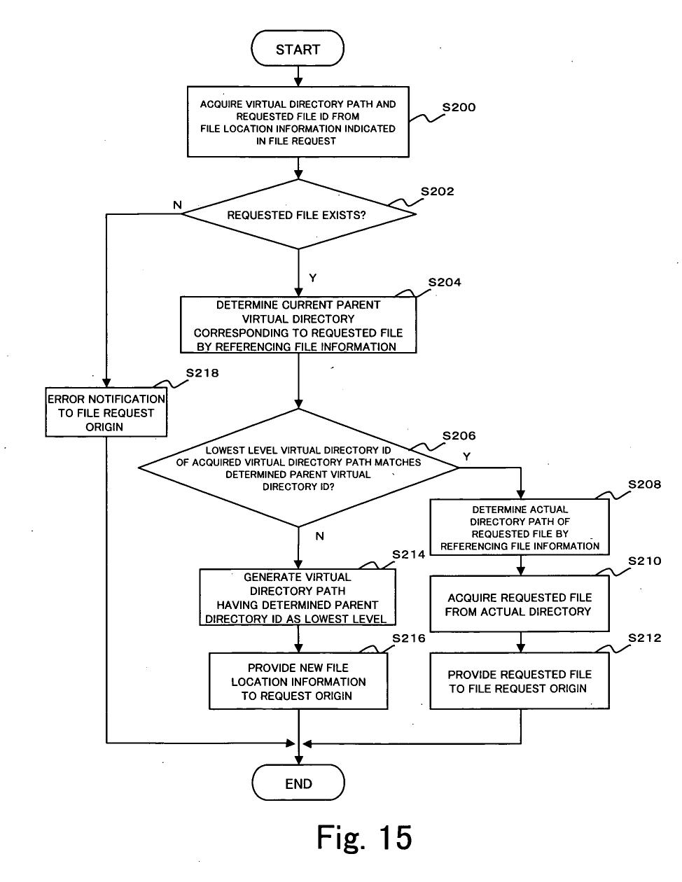

The procedure of the file request processor 12 when the file request is received from the client 30 in the second modified example will be described with reference to the flowchart shown in FIG. 15.

When the file request is received from the client 30, the file request processor 12 acquires (S200) the virtual directory path and the file ID of the requested file from the file location information that is indicated in the file request. The file request processor 12 judges (S202) whether or not the requested file exists by referencing the file information 19. As a result of the judgment, if the requested file does not exist (judgment result of S202 is “N”), the file request processor 12 issues an error notification (S218) to the client 30 originating the file request indicating that the requested file does not exist.

On the other hand, as a result of the judgment at S202, if the requested file exists (judgment result of S202 is “Y”), the file request processor 12 determines (S204) the virtual directory ID of the virtual directory where the requested file is now virtually stored, namely, the parent virtual directory ID, by referencing the file information 19. Next, the file request processor 12 judges (S206) whether or not the acquired virtual directory path matches the path created by moving up the parent until the root directory by referencing the virtual directory information 17 from the determined parent virtual directory ID. If a match results from the judgment (judgment result of S206 is “Y”), the file request processor 12 determines (S208) the actual directory path corresponding to the acquired file ID by referencing the file information 19. Next, the file request processor 12 acquires (S210) the requested file from the actual directory indicated at the lowest level of the determined actual directory path and provides (S212) the requested file to the client 30 originating the file request.

On the other hand, if a match does not result from the judgment at S206 (judgment result at S206 is “N”), the file request processor 12 judges that the requested file has moved from the virtual directory path that was indicated in the file location information. The file request processor 12 then generates (S214) a virtual directory path with the determined parent virtual directory ID at the lowest level by referencing the virtual directory information 17. Next, the file request processor 12 generates file location information indicating the file ID of the requested file and the generated virtual directory path, and provides (S216) the generated file location information to the client 30 originating the file request.

According to the second modified example described above, the client 30 is provided with new file location information even if the requested file has moved and the file request is made to the file server 10 using previous file location information. Thus, the client 30 can ultimately acquire the requested file if the file is again requested using the new file location information. Furthermore, since new file location information is provided to the client 30 in response to the file request, the user can determine that the requested file has moved to another virtual directory. Moreover, the file location information that is used when the client 30 requests a file includes a virtual directory path indicating the virtual storage location of the file. Thus, by referencing the file location information, the user can determine under what directory the file exists.

Furthermore, a globally unique virtual directory ID is assigned to each virtual directory. Thus, according to the second modified example, virtual directories having the same name can exist in the same level.

Next, a third modified example of the embodiment will be described. As, in the first modified example, when the requested file has already moved to another virtual directory, the file request processor 12 provides the requested file together with the file location information to the client 30 originating the request in response to the file request.

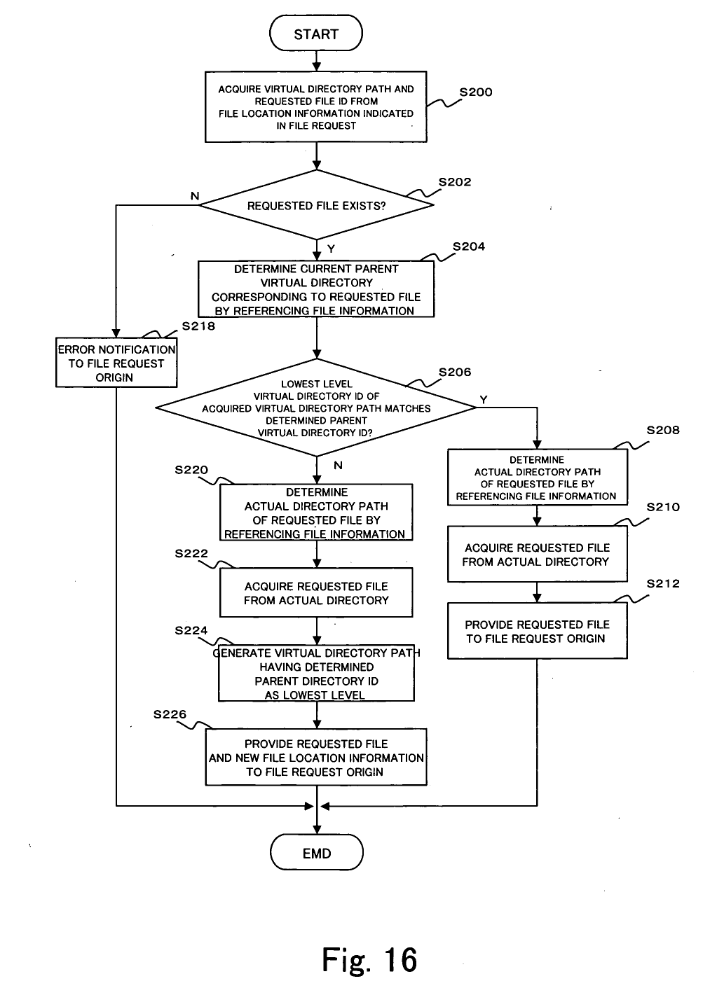

FIG. 16 is a flowchart showing a procedure of the file request processor 12 when a file request is received from the client 30. Processes in FIG. 16 that are identical to those in FIG. 15 are assigned identical reference characters and their descriptions will be omitted. The processes from S206 will be described.

If the requested file in FIG. 16 has already moved to another virtual directory, namely, if the judgment result at S206 is “N”, the file request processor 12 determines (S220) the current virtual directory path and the actual directory path corresponding to the requested file by referencing the file information 19. Next, the file request processor 12 acquires (S222) the requested file from the actual directory located at the lowest level of the determined actual directory path. Furthermore, the file request processor 12 generates (S224) a virtual directory path having the determined parent virtual directory ID at the lowest level by referencing the virtual directory information 17. The file request processor 12 generates new file location information indicating the generated virtual directory path the file ID of the requested file and provides (S226) the new file location information and the acquired requested file to the client 30 originating the file request.

According to the third modified example described above, even if the requested file has moved and the file request is made to the file server 10 using previous file location information, the client 30 can acquire the requested file and new file location information in response to the file request.

Next, a fourth modified example of the embodiment will be described. In the fourth modified example, multiple file servers are arranged in the file management system and the movement of files between the file servers will be described.

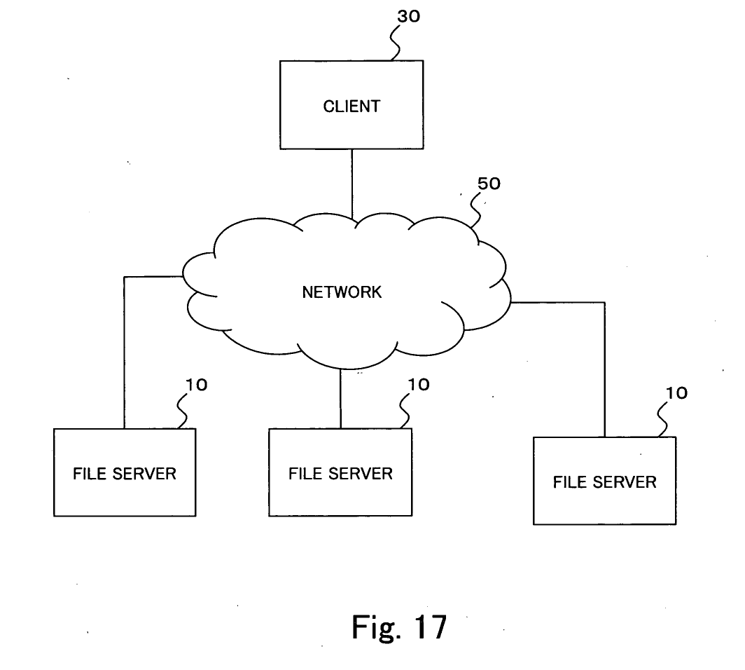

FIG. 17 shows a configuration of the file management system in the fourth modified example. As shown in FIG. 17, multiple file servers 10 are connected via the network 50. Each file server is assigned a globally unique server ID in the file management system. The server ID is, for example, a host name or IP address.

In the above-mentioned embodiment and modified examples, the file request server 12 searches the file IDs registered in the file information 19 to see whether the file ID of the requested file is included. If the file ID could not be found, an error notification is issued to the client 30 originating the file request (S2116 in FIG. 7 and FIG. 8 and S218 in FIG. 15 and FIG. 16). However, in the fourth modified example, if the requested file could not be found, the file request processor 12 inquires at the other file servers 10 as to whether the requested file is stored.

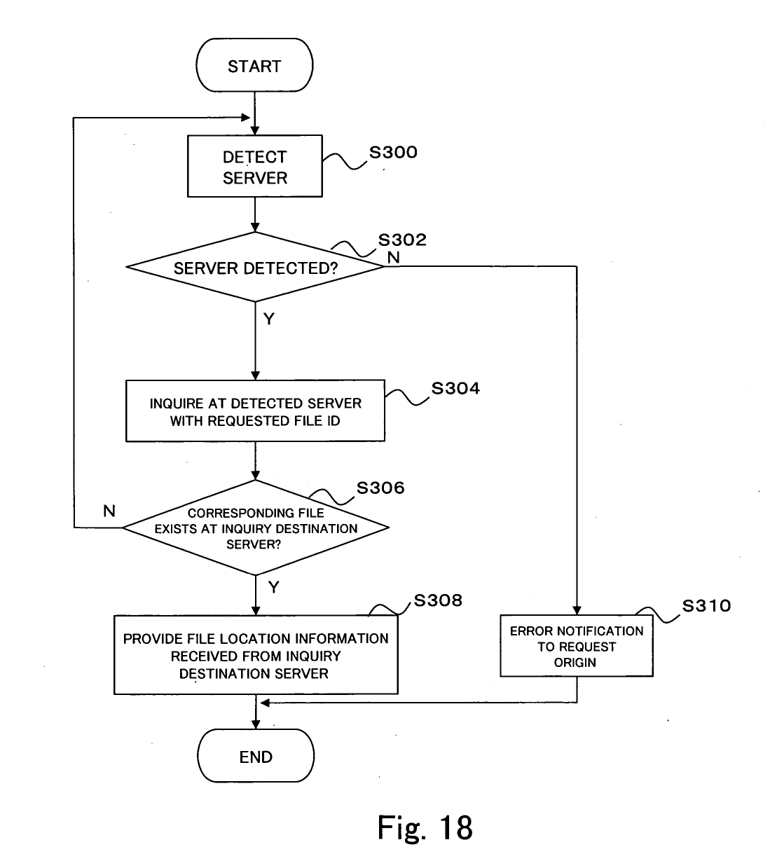

FIG. 18 is a flowchart showing a procedure when the file request processor 12 inquires at another file server if the requested file could not be found.

In FIG. 18, the file request processor 12 first detects (S300) the other file servers. The detection of the other file servers can be performed by broadcasting a predetermined message for the detection of other servers from the file request processor 12 to the network 50. The other file servers have a protocol for recognizing and responding to the message for the detection of other servers. Namely, after the message for the detection of other servers is received, the file servers respond to the file request processor 12 in accordance with the protocol. The file request processor 12 receives the responses from the other file servers. As a result, the other file servers forming the system can be discovered. Another method is to have each file server store a list of server IDs of the other file servers.

If the other file servers could not be found (judgment result of S302 is “N”), the file request processor 12 issues an error notification (S310) to the client 30 originating the request. On the other hand, if the other file servers are found (judgment result of S302 is “Y”), the file request processor 12 sends to the other file servers an inquiry (S304) including the file ID that is included in the file location information and received from the client 30. If the other file servers receiving this inquiry have the file corresponding to the file ID, new file location information corresponding to the file is provided to the file request processor 12. The operation of the other file servers receiving the inquiry will be described later.

If, as a result of this inquiry, it is found that the other file servers under inquiry do not have the file (judgment result of S306 is “N”), the detection of the other file servers (S300) and the corresponding inquiry (S302) are repeated until other file servers cannot be detected. On the other hand, if, as a result of the inquiry, the other inquired file servers have the file (judgment result of S306 is “Y”), the file request processor 12 provides (S308) the file location information received from the other inquired file servers to the client 30 originating the request.

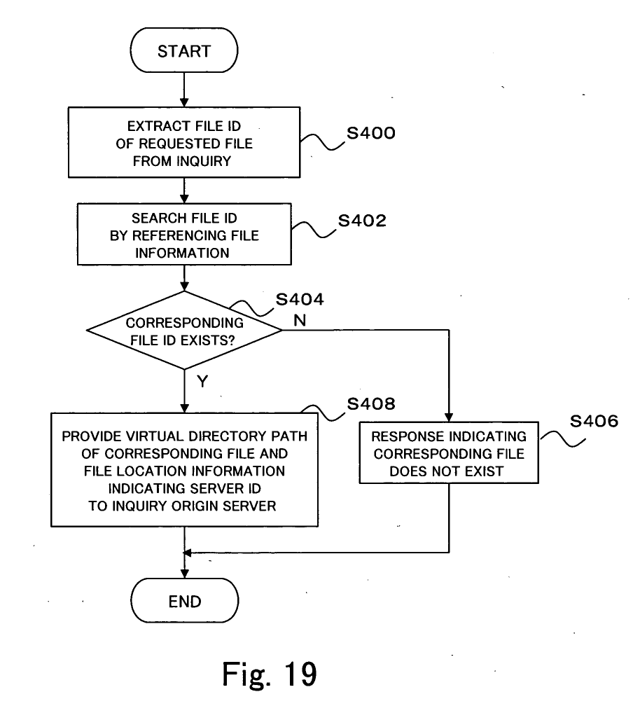

Next, the procedure of the file request processor 12 will be described with reference to the flowchart shown in FIG. 19 when the above-mentioned inquiry is received from the other file servers.

In FIG. 19, the file request processor 12 extracts (S400) the file ID of the requested file from the inquiry. Next, the file request processor 12 searches (S402) for the extracted file ID by referencing the file information 19. As a result of the search, if the file ID could not be found (judgment result of S404 is “N”), the file request processor 12 notifies (S406) the inquiring file server that the file does not exist.

On the other hand, if, as a result of the search, the file exists (judgment result at S404 is “Y”), the file request processor 12 generates a virtual directory path for the file by referencing the virtual directory information 17 and the file information 19. The generation of the virtual directory path may be accomplished in the same manner as the above-mentioned embodiment or modified examples. Next, the file request processor 12 generates file location information to include at least the generated virtual directory path, the file ID of the file, and its own server ID and provides (S408) the file location information to the inquiring file server.

According to the fourth modified example described above, if the requested file does not exist at the file server that received the file request but the requested file does exist at another file server, the file location information corresponding to the requested file is provided to the client 30 originating the file request. Thus, the client 30 can acquire the requested file by using the new file location information that was received in response to the file request.

Next, a fifth modified example of the embodiment will be described. The fifth modified example differs from the above-mentioned embodiment and modified examples with respect to retaining a history when a file has moved between virtual directories.

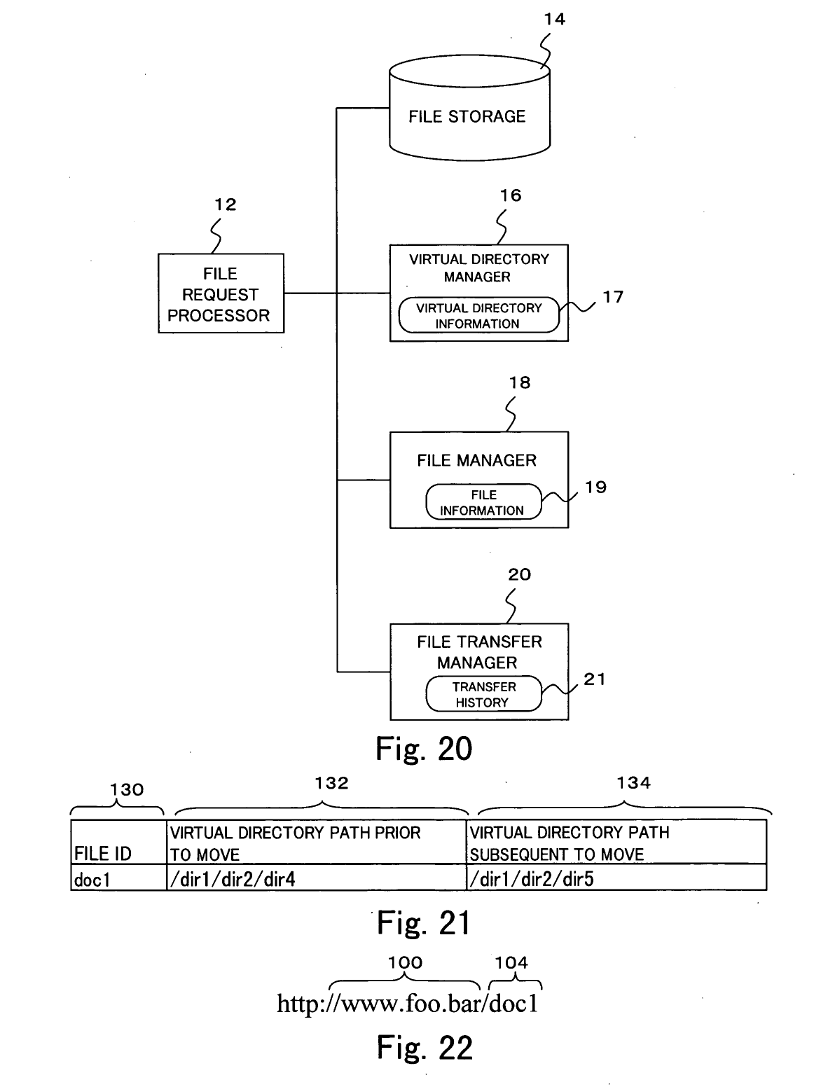

FIG. 20 is a functional block diagram of the file server 10 in the fifth modified example. Functional blocks in FIG. 20 that are identical to those in FIG. 3 are assigned identical reference characters and their descriptions will be omitted. A file movement manager 20 monitors the movement of files between virtual directories and a movement history 21 is retained. As shown in FIG. 21, the movement history 21 indicates a file ID 130 of the requested file, a pre-move virtual directory path 132, and a post-move virtual directory path 134.

If, by executing the processes described in the above-mentioned embodiment and modified examples, it is judged the requested file has moved and the file request processor 12 references the movement history 21 without generating a virtual directory path corresponding to the requested file. The file request processor 12 then searches for the pre-move virtual directory path that matches the virtual directory path, which is indicated in the file location information, from among the pre-move virtual directory paths that correspond to the file ID of the requested file. The file request processor 12 then determines the post-move virtual directory path corresponding to the found pre-move virtual directory path by referencing the movement history 21 and generates new file location information to include the determined virtual directory path.

If the requested file has moved in the fifth modified example described above, the file request processor 12 determines the post-move virtual directory path by referencing the movement history 21 retained in the file movement manager 20.

In the above-mentioned embodiment and modified examples, the file location information indicated in the file request was described as including the virtual directory path as shown in FIG. 2 and FIG. 9. However, since the file ID is a globally unique identifier in the file management system, the requested file can be determined if only the file ID is identified. Thus, the file request processor 12 can determine the requested file from only the host name 100 and the file ID 104 of the requested file during the file request that are indicated in the file location information indicated in the file request as shown in FIG. 22. In this case, the file request processor 12 may be designed so that the file location information is generated to include the virtual directory path as shown in FIG. 2 and FIG. 9 and the generated file location information is provided together with the requested file to the client 30 originating the file request. As a result, the requested file can be acquired also if the user knows only the file ID of the requested file. Furthermore, in this case, the user can guess under what directory the requested file currently exists by referencing the provided file location information. In the above-mentioned embodiment and modified examples, the file IDs were described as being globally unique identifiers. However, if the files are not shared among multiple file servers but are individually managed at every file server, the file IDs need not be globally unique identifiers and file IDs that are unique identifiers within a single file server can be used.

Furthermore, the file location information indicated in the file request may indicate the actual directory path and not the virtual directory path.

What is claimed is:

1. A computer readable medium storing a program causing a computer to execute a process for providing a file in response to a file request, the process comprising:
acquiring, when a file request is received from a client, a file ID that uniquely identifies the requested file and a directory path from file location information that is indicated in the received file request;
judging whether or not the file corresponding to the acquired file ID exists on the acquired directory path; and
if, as a result of the judgment, the file corresponding to the acquired file ID exists, acquiring the file corresponding to the acquired file ID and providing the acquired file as the requested file to the client, wherein
if, as a result of the judgment, a file corresponding to the acquired file ID does not exist, a current directory path corresponding to the acquired file ID is determined, file location information indicating the determined current directory path and the acquired file ID is generated, and the generated file location information is provided to the client in response to the file request.

2. A recording medium according to claim 1, wherein:
the directory is a virtual directory indicating a virtual storage location of a file;
a current virtual directory path corresponding to the acquired file ID is determined by referencing file information that associates file ID, current virtual directory path of the file, and actual directory path indicating an actual storage location of the file, and whether or not a file corresponding to the acquired file ID exists on the acquired virtual directory path is judged on the basis of whether or not the determined current virtual directory path matches the acquired virtual directory path;
if the determined current virtual directory path matches the acquired virtual directory path, the requested file is judged to exist on the acquired virtual directory path, the actual directory path corresponding to the acquired file ID is determined by referencing the file information, the file corresponding to the acquired file ID from the determined actual directory path is acquired, and the acquired file is provided as the requested file to the client.

3. A recording medium according to claim 2, wherein:
if the determined virtual directory path does not match the acquired virtual directory path, the requested file is judged not to exist on the acquired virtual directory path, file location information indicating the determined virtual directory path and the acquired file ID is generated, and the generated file location information is provided to the client in response to the file request.

4. A recording medium according to claim 1, wherein:
the directory is a virtual directory indicating a virtual storage location of a file;
a virtual directory path indicating file location information comprises at least one directory ID that uniquely identifies a virtual directory;
a directory ID of a current virtual directory in which is virtually stored a file corresponding to the acquired file ID is determined by referencing file information-that associates file ID, directory ID of a current virtual directory indicating a virtual storage location of the file, and an actual directory path indicating actual storage location of the file, whether or not a file corresponding to the acquired file ID exists on the acquired virtual directory path is judged on the basis of whether or not the determined directory ID matches a lowest level directory ID in the acquired virtual directory path;
if the directory IDs match, the requested file is judged to exist on the acquired virtual directory path, the actual directory path corresponding to the acquired file ID is determined, the file is acquired from the determined actual directory path, and the acquired file is provided as the requested file to the client.

5. A recording medium according to claim 4, wherein:
if the directory IDs do not match, the requested file is judged not to exist on the acquired virtual directory path, a virtual directory path is generated with the determined directory ID at the lowest level by referencing virtual directory information that indicates information on the current virtual directory structure, file location information indicating the generated virtual directory path and the acquired file ID is generated, and the generated file location information is provided to the client in response to the file request.

6. A file server that provides a file to a client, the file server comprising:
an acquiring section that acquires, when a file request is received from the client, a file ID that uniquely identifies the requested file and a directory path from file location information indicated in the received file request;
a judgment section that judges whether or not a file corresponding to the acquired file ID exists on the acquired directory path; and
a provider section that acquires a file corresponding to the acquired file ID if, as a result of the judgment, the file corresponding to the acquired file ID exists, and provides the acquired file as the requested file to the client, wherein
if, as a result of the judgment, a file corresponding to the acquired file ID does not exist, a current directory path corresponding to the acquired file ID is determined, file location information indicating the determined current directory path and the acquired file ID is generated, and the generated file location information is provided to the client in response to the file request.

7. A file providing method for a file server to provide a file to a client, the file providing method comprising the steps of the file server:
acquiring, when a file request is received from the client, a file ID that uniquely identifies the requested file and a directory path from file location information that is indicated in the received file request;
judging whether or not the file corresponding to the acquired file ID exists on the acquired directory path; and
if, as a result of the judgment, the file corresponding to the acquired file ID exists, acquiring the file corresponding to the acquired file ID and providing the acquired file as the requested file to the client, wherein
if, as a result of the judgment, a file corresponding to the acquired file ID does not exist, a current directory path corresponding to the acquired file ID is determined, file location information indicating the determined current directory path and the acquired file ID is generated, and the generated file location information is provided to the client in response to the file request.
